(19) United States
(12) Patent Application Publication
(10) Pub. No.: US 2024/0089247 A1
(43) Pub. Date: Mar. 14, 2024

(54) SYSTEMS AND METHODS FOR EXTRACTING DISCRETE DATA FROM A DATA UNIT AND MANAGING ACCESS THERETO USING ELECTRONIC DIGITAL CERTIFICATES

(71) Applicant: BANK OF AMERICA CORPORATION, Charlotte, NC (US)

(72) Inventor: Shailendra Singh, Thane West (IN)

(73) Assignee: BANK OF AMERICA CORPORATION, Charlotte, NC (US)

(21) Appl. No.: 17/943,931

(22) Filed: Sep. 13, 2022

(51) Int. Cl. H04L 9/40; G06F 21/64; H04L 9/32

(52) U.S. Cl. CPC H04L 63/0823; G06F 21/64; H04L 9/3268

(57) ABSTRACT

Systems, computer program products, and methods are described herein for extracting discrete data from a data unit and managing access thereto using electronic digital certificates. The present invention may be configured to receive data units including content, identify discrete data for each data unit, and determine, for each discrete data, qualifications permitting access to the discrete data. The present invention may be configured to generate electronic digital certificates associated with the discrete data and store the electronic digital certificates on a distributed ledger. The present invention may be configured to generate, on the distributed ledger, smart contracts for managing access to the electronic digital certificates by generating smart contracts permitting access to the electronic digital certificates based on the qualifications. The present invention may be configured to automatically permit and/or prevent, using the smart contracts and based on the distributed ledger, access by applications to discrete data.

### FIELD OF THE INVENTION

The present invention embraces systems and methods for extracting discrete data from a data unit and managing access thereto using electronic digital certificates.

### BACKGROUND

An electronic system may be configured to permit and prevent one or more applications from accessing data units. For example, the electronic system may permit and prevent access to a data unit based on one or more data security rules, which determine whether or not applications qualify for accessing the data unit.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, the present invention embraces a system for extracting discrete data from a data unit and managing access thereto using electronic digital certificates. The system may include at least one processing device, and at least one non-transitory storage device may include computer-executable program code that, when executed by the at least one processing device, causes the at least one processing device to receive, from a plurality of input channels, data units, where each data unit of the data units includes content and identify, using a machine learning model and for each data unit of the data units, content segments in the data unit, where each content segment of the content segments is a portion of the content of the data unit. The at least one non-transitory storage device may include computer-executable program code that, when executed by the at least one processing device, causes the at least one processing device to determine, for each content segment of the content segments, qualifications permitting access to the content segment, generate, for each content segment of the content segments, an electronic digital certificate to generate electronic digital certificates associated with the content segments, and store the electronic digital certificates on a distributed ledger. The at least one non-transitory storage device may include computer-executable program code that, when executed by the at least one processing device, causes the at least one processing device to generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated. The at least one non-transitory storage device may include computer-executable program code that, when executed by the at least one processing device, causes the at least one processing device to automatically permit, using the smart contracts and based on the distributed ledger, applications to access first content segments of the data units based on determining that the applications satisfy the qualifications permitting access to the first content segments. The at least one non-transitory storage device may include computer-executable program code that, when executed by the at least one processing device, causes the at least one processing device to automatically prevent, using the smart contracts and based on the distributed ledger, the applications from accessing second content segments of the data units based on determining that the applications do not satisfy the qualifications permitting access to the second content segments.

In some embodiments, the at least one non-transitory storage device may include computer-executable program code that, when executed by the at least one processing device, causes the at least one processing device to receive, from an application having attributes, a request to access a first data unit of the data units, determine, using the smart contracts and based on the attributes of the application, a first content segment of the first data unit the application is permitted to access and a second content segment of the first data unit the application is not permitted to access, and provide, to the application, access to the first content segment while preventing the application from accessing the second content segment.

In some embodiments, for each data unit of the data units, each content segment of the content segments may include a field of the data unit and data in the field.

In some embodiments, the at least one non-transitory storage device may include computer-executable program code that, when executed by the at least one processing device, causes the at least one processing device to, when determining the qualifications permitting access to the content segment, determine the qualifications based on a data security rule database.

In some embodiments, the at least one non-transitory storage device may include computer-executable program code that, when executed by the at least one processing device, causes the at least one processing device to, when determining the qualifications permitting access to the content segment, determine the qualifications based on characteristics of the content segment, where the characteristics include whether the content segment includes personally identifiable information, whether the content segment includes confidential information, one or more uses of the content segment, a type of data in the content segment, a type of a data unit containing the content segment, and/or the like.

In some embodiments, the machine learning model may be a first machine learning model, and the at least one non-transitory storage device may include computer-executable program code that, when executed by the at least one processing device, causes the at least one processing device to, when determining the qualifications permitting access to the content segment, determine the qualifications using a second machine learning model.

In some embodiments, the at least one non-transitory storage device may include computer-executable program code that, when executed by the at least one processing device, causes the at least one processing device to, when determining qualifications, determine, for a third content segment of the content segments, a first qualification permitting access to the third content segment and a second qualification permitting access to the third content segment and, when generating the smart contracts, generate, for a third electronic digital certificate generated for the third content segment, a third smart contract permitting access to the third electronic digital certificate based on the first qualification and generate, for the third electronic digital certificate, a fourth smart contract permitting access to the third electronic digital certificate based on the second qualification.

In some embodiments, the at least one non-transitory storage device may include computer-executable program code that, when executed by the at least one processing device, causes the at least one processing device to store the smart contracts in a smart contracts database.

In some embodiments, the at least one non-transitory storage device may include computer-executable program code that, when executed by the at least one processing device, causes the at least one processing device to store the smart contracts on the distributed ledger.

In some embodiments, the at least one non-transitory storage device may include computer-executable program code that, when executed by the at least one processing device, causes the at least one processing device to, when generating the electronic digital certificates, generate, for each content segment of the content segments, the electronic digital certificate based on the content segment.

In some embodiments, the machine learning model may be a first machine learning model, and the at least one non-transitory storage device may include computer-executable program code that, when executed by the at least one processing device, causes the at least one processing device to determine, using a second machine learning model, that a first data unit is valid for a first time period, where the first data unit includes a first plurality of content segments, and when generating smart contracts, generate, for a first plurality of electronic digital certificates generated for the first plurality of content segments, first smart contracts to only permit access to the first plurality of electronic digital certificates during the first time period.

In some embodiments, the machine learning model may be a first machine learning model, and the at least one non-transitory storage device may include computer-executable program code that, when executed by the at least one processing device, causes the at least one processing device to determine, using a second machine learning model, that a first data unit is valid for a first time period, where the first data unit includes a first plurality of content segments, and record, after the first time period and on the distributed ledger, a null set as owner of first electronic digital certificates generated for the first plurality of content segments to prevent access to the first plurality of content segments.

In some embodiments, the at least one non-transitory storage device may include computer-executable program code that, when executed by the at least one processing device, causes the at least one processing device to receive, from a printing device, a request to print a first data unit including a first content segment and a second content segment, where the request is associated with a user, determine, using the smart contracts and based on the distributed ledger, whether the user is permitted to access the first content segment, determine, using the smart contracts and based on the distributed ledger, whether the user is permitted to access the second content segment, and provide, to the printing device, in response to determining that the user is permitted to access the first content segment, and in response to determining that the user is not permitted to access the second content segment, a modified version of the first data unit for printing, where the modified version includes the first content segment and does not include the second content segment.

In some embodiments, the at least one non-transitory storage device may include computer-executable program code that, when executed by the at least one processing device, causes the at least one processing device to initiate, with a scanning device and in response to input from a user, a scanning operation of a first data unit, identify, during the scanning operation and using the machine learning model, a first content segment and a second content segment in the first data unit, determine, during the scanning operation, using the smart contracts, and based on the distributed ledger, whether the user is permitted to access the first content segment, determine, during the scanning operation, using the smart contracts, and based on the distributed ledger, whether the user is permitted to access the second content segment, and generate, with the scanning device, in response to determining that the user is permitted to access the first content segment, and in response to determining that the user is not permitted to access the second content segment, a modified scan of the first data unit, where the modified scan includes the first content segment and does not include the second content segment.

In another aspect, the present invention embraces a computer program product for extracting discrete data from a data unit and managing access thereto using electronic digital certificates. The computer program product may include a non-transitory computer-readable medium including code that, when executed by a first apparatus, causes the first apparatus to receive, from a plurality of input channels, data units, where each data unit of the data units includes content, and identify, using a machine learning model and for each data unit of the data units, content segments in the data unit, where each content segment of the content segments is a portion of the content of the data unit. The computer program product may include a non-transitory computer-readable medium including code that, when executed by a first apparatus, causes the first apparatus to determine, for each content segment of the content segments, qualifications permitting access to the content segment, generate, for each content segment of the content segments, an electronic digital certificate to generate electronic digital certificates associated with the content segments, and store the electronic digital certificates on a distributed ledger. The computer program product may include a non-transitory computer-readable medium including code that, when executed by a first apparatus, causes the first apparatus to generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated. The computer program product may include a non-transitory computer-readable medium including code that, when executed by a first apparatus, causes the first apparatus to automatically permit, using the smart contracts and based on the distributed ledger, applications to access first content segments of the data units based on determining that the applications satisfy the qualifications permitting access to the first content segments. The computer program product may include a non-transitory computer-readable medium including code that, when executed by a first apparatus, causes the first apparatus to automatically prevent, using the smart contracts and based on the distributed ledger, the applications from accessing second content segments of the data units based on determining that the applications do not satisfy the qualifications permitting access to the second content segments.

In some embodiments, the computer program product may include a non-transitory computer-readable medium including code that, when executed by a first apparatus, causes the first apparatus to receive, from an application having attributes, a request to access a first data unit of the data units, determine, using the smart contracts and based on the attributes of the application, a first content segment of the first data unit the application is permitted to access and a second content segment of the first data unit the application is not permitted to access, and provide, to the application, access to the first content segment while preventing the application from accessing the second content segment.

In some embodiments, for each data unit of the data units, each content segment of the content segments may include a field of the data unit and data in the field.

In some embodiments, the computer program product may include a non-transitory computer-readable medium including code that, when executed by a first apparatus, causes the first apparatus to, when determining the qualifications permitting access to the content segment, determine the qualifications based on a data security rule database.

In some embodiments, the computer program product may include a non-transitory computer-readable medium including code that, when executed by a first apparatus, causes the first apparatus to, when determining the qualifications permitting access to the content segment, determine the qualifications based on characteristics of the content segment, where the characteristics include whether the content segment includes personally identifiable information, whether the content segment includes confidential information, one or more uses of the content segment, a type of data in the content segment, a type of a data unit containing the content segment, and/or the like.

In yet another aspect, a method for extracting discrete data from a data unit and managing access thereto using electronic digital certificates is presented. The method may include receiving, from a plurality of input channels, data units, where each data unit of the data units includes content and identifying, using a machine learning model and for each data unit of the data units, content segments in the data unit, where each content segment of the content segments is a portion of the content of the data unit. The method may include determining, for each content segment of the content segments, qualifications permitting access to the content segment, generating, for each content segment of the content segments, an electronic digital certificate to generate electronic digital certificates associated with the content segments, and storing the electronic digital certificates on a distributed ledger. The method may include generating, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated. The method may include automatically permitting, using the smart contracts and based on the distributed ledger, applications to access first content segments of the data units based on determining that the applications satisfy the qualifications permitting access to the first content segments. The method may include automatically preventing, using the smart contracts and based on the distributed ledger, the applications from accessing second content segments of the data units based on determining that the applications do not satisfy the qualifications permitting access to the second content segments,
The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for extracting discrete data from a data unit and managing access thereto using electronic digital certificates, in accordance with an embodiment of the invention;

FIG. 2A illustrates an exemplary process flow for creating an electronic digital certificate, in accordance with an embodiment of the invention;

FIG. 2B illustrates and exemplary electronic digital certificate, in accordance with an embodiment of the invention;

FIG. 3 illustrates an exemplary machine learning (ML) subsystem architecture, in accordance with an embodiment of the invention;

FIG. 4 illustrates an exemplary system flow for extracting discrete data from a data unit and managing access thereto using electronic digital certificates, in accordance with an embodiment of the invention;

FIG. 5A illustrates an exemplary secure data unit content bifurcation apparatus, in accordance with an embodiment of the invention;

FIG. 5B illustrates an exemplary process flow for extracting discrete data from a data unit and managing access thereto using electronic digital certificates, in accordance with an embodiment of the invention;

FIG. 6 illustrates an exemplary process flow for extracting discrete data from a data unit and managing access thereto using electronic digital certificates, in accordance with an embodiment of the invention;

FIG. 7 illustrates an exemplary process flow for managing access to discrete data from data units using electronic digital certificates, in accordance with an embodiment of the invention; and

FIG. 8 illustrates an exemplary process flow for extracting discrete data from a data unit and managing access thereto using electronic digital certificates, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As noted, an electronic system may be configured to permit and prevent one or more applications from accessing data units. For example, the electronic system may permit and prevent access to a data unit based on one or more data security rules, which determine whether or not applications qualify for accessing the data unit. However, the data unit may include multiple elements of discrete data, and the one or more data security rules may permit an application to access all of the elements of discrete data in the data unit based on a characteristic of the data unit, even though the application only needs access to a subset of the elements of discrete data. By permitting the application to access all of the elements of discrete data in the data unit, the electronic system exposes the discrete data to potential misuse or misappropriation. For example, if the data unit includes personally identifiable information and/or confidential information and the electronic system permits the application to access the data unit, the application may copy, store, transmit, and/or the like the entire data unit including the personally identifiable information and/or confidential information to another storage location, to another system, to another device, and/or the like that is not permitted to access personally identifiable information and/or confidential information. Such misuse and/or misappropriation as well as actions taken to identify, mitigate, correct, report to authorities, report to users, and/or the like consumes significant computing resources (e.g., processing resources, memory resources, power resources, communication resources, and/or the like) and/or network resources.

Furthermore, elements of discrete data in the data unit may become obsolete (e.g., may be invalid after a period of time has passed, after a particular date, and/or the like). In such a situation, permitting the application to access all of the elements of discrete data in the data unit results in the application using obsolete data to perform calculations, to perform analyses, to generate reports, and/or the like, which consumes significant computing resources (e.g., processing resources, memory resources, power resources, communication resources, and/or the like) and/or network resources. Additionally, identifying, mitigating, correcting, reporting, and/or the like such actions taken using obsolete data consumes further computing resources (e.g., processing resources, memory resources, power resources, communication resources, and/or the like) and/or network resources.

Some embodiments described herein provide a system, a computer program product, and/or a method for extracting discrete data from a data unit and managing access thereto using electronic digital certificates. For example, a system (e.g., an electronic system for extracting discrete data from a data unit and managing access thereto using electronic digital certificates and/or the like) may be configured to receive, from a plurality of input channels, data units, where each data unit of the data units includes content and identify, using a machine learning model and for each data unit of the data units, content segments in the data unit, where each content segment of the content segments is a portion of the content of the data unit. The system may be configured to determine, for each content segment of the content segments, qualifications permitting access to the content segment, generate, for each content segment of the content segments, an electronic digital certificate to generate electronic digital certificates associated with the content segments, and store the electronic digital certificates on a distributed ledger. The system may be configured to generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated. The system may be configured to automatically permit, using the smart contracts and based on the distributed ledger, applications to access first content segments of the data units based on determining that the applications satisfy the qualifications permitting access to the first content segments and automatically prevent, using the smart contracts and based on the distributed ledger, the applications from accessing second content segments of the data units based on determining that the applications do not satisfy the qualifications permitting access to the second content segments.

By using the machine learning model to identify content segments in each data unit, determining qualifications permitting access to each content segment, generating electronic digital certificates for each content segment, storing the electronic digital certificates on a distributed ledger, generating smart contracts for managing access to the electronic digital certificates, and permitting and preventing applications from accessing each content segment based on the smart contracts and the distributed ledger, the system may manage access to each content segment in a given data unit. By managing access to each content segment in this manner, applications may not access all of the elements of discrete data in the data unit, and the system can prevent exposure of the discrete data to potential misuse or misappropriation. For example, if a data unit includes personally identifiable information and/or confidential information, the system may prevent an application from accessing the personally identifiable information and/or confidential information, while still permitting the application to access other data in the data unit. By doing so, the system prevents the application from copying, storing, transmitting, and/or the like the personally identifiable information and/or confidential information to another storage location, to another system, to another device, and/or the like that is not permitted to access personally identifiable information and/or confidential information. By preventing such misuse and/or misappropriation as well as actions taken to identify, mitigate, correct, report to authorities, report to users, and/or the like, the system conserves significant computing resources (e.g., processing resources, memory resources, power resources, communication resources, and/or the like) and/or network resources.

Furthermore, and as noted, elements of discrete data in the data unit may become obsolete (e.g., may be invalid after a period of time has passed, after a particular date, and/or the like). In some embodiments, the system may be configured to determine (e.g., using a machine learning model) which elements of discrete data (e.g., content segments) will become obsolete and/or invalid and when the elements of discrete data will become obsolete and/or invalid. The system may be configured to generate a smart contract for such elements such that applications are only permitted to access such elements while the elements are valid. Additionally, or alternatively, the system may be configured to, after such elements become invalid, record, on a distributed ledger, a null set as owner of electronic digital certificates associated with such elements. By only permitting applications to access such elements while the elements are valid, the system prevents the applications from using obsolete data to perform calculations, to perform analyses, to generate reports, and/or the like, thereby conserving significant computing resources (e.g., processing resources, memory resources, power resources, communication resources, and/or the like) and/or network resources. Finally, preventing the applications from using obsolete data to perform calculations, to perform analyses, to generate reports, and/or the like conserves computing resources (e.g., processing resources, memory resources, power resources, communication resources, and/or the like) and/or network resources that would otherwise be consumed by identifying, mitigating, correcting, reporting, and/or the like such actions taken using obsolete data.

As used herein, an “entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or or the like, employing information technology resources for processing large amounts of data.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein.

As used herein, a “user interface” may be any device or software that allows a user to input information, such as commands and/or data, into a device, and/or that allows the device to output information to the user. For example, a user interface may include an application programmer interface (API), a graphical user interface (GUI), and/or an interface to input computer-executable instructions that direct a processing device to carry out functions. The user interface may employ input and/or output devices to input data received from a user and/or output data to a user. Input devices and/or output devices may include a display, API, mouse, keyboard, button, touchpad, touch screen, microphone, speaker, LED, light, joystick, switch, buzzer, bell, and/or other devices for communicating with one or more users.

As used herein, a “resource” may generally refer to computing resources, computing services, objects, products, devices, goods, commodities, services, offers, discounts, currency, cash, cash equivalents, rewards, reward points, benefit rewards, bonus miles, cash back, credits, and/or the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source retainer” may generally refer to an account, a system, and/or the like associated with a user and/or a type of resources, such as software, a checking account, a deposit account, a savings account, a credit account, a rewards account, a rewards points account, a benefit rewards account, a bonus miles account, a cash back account, and/or the like, which may be managed and/or maintained by an entity, such as a financial institution, an electronic resource transfer institution (e.g., a credit card company, a debit card company, a prepaid card company, and/or the like), a credit union, and/or the like.

As used herein, a “distribution,” a “transfer,” and/or an “allocation” may refer to any transaction, activities, and/or communication between one or more entities, between a user and one or more entities, and/or the like. A resource distribution, a resource transfer, and/or an allocation of resources may refer to any distribution of resources such as, but not limited to, provision of computing resources, provision of computing services, a payment, processing of funds, purchase of goods or services, a return of goods or services, a payment transaction, a credit transaction, other interactions involving a user's resource or account, and/or the like. Unless specifically limited by the context, a “resource distribution,” an “allocation of resources,” a “resource transfer,” a “transaction,” a “transaction event,” and/or a “point of transaction event” may refer to any activity between a user, a merchant, an entity, and/or the like. In the context of an entity such as a financial institution, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that invokes or is detectable by the financial institution.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, an “engine” may refer to core elements of a computer program, part of a computer program that serves as a foundation for a larger piece of software and drives the functionality of the software, and/or the like. An engine may be self-contained but may include externally controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “authentication credentials” may be any information that may be used to identify a user. For example, a system may prompt a user to enter authentication information such as a username, a password, a token, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like. In some embodiments, an interaction may refer to an entity, a user, a system, and/or a device providing an advertisement, information, data, a user interface, and/or the like to another entity, another user, another system, and/or another device.

As described herein, one or more systems, devices, and/or the like may use electronic digital certifications, such as a non-fungible token (NFT). An NFT is a cryptographic record (referred to as “tokens”) linked to a resource. An NFT is typically stored on a distributed ledger that certifies ownership and authenticity of the resource and is exchangeable in a peer-to-peer network.

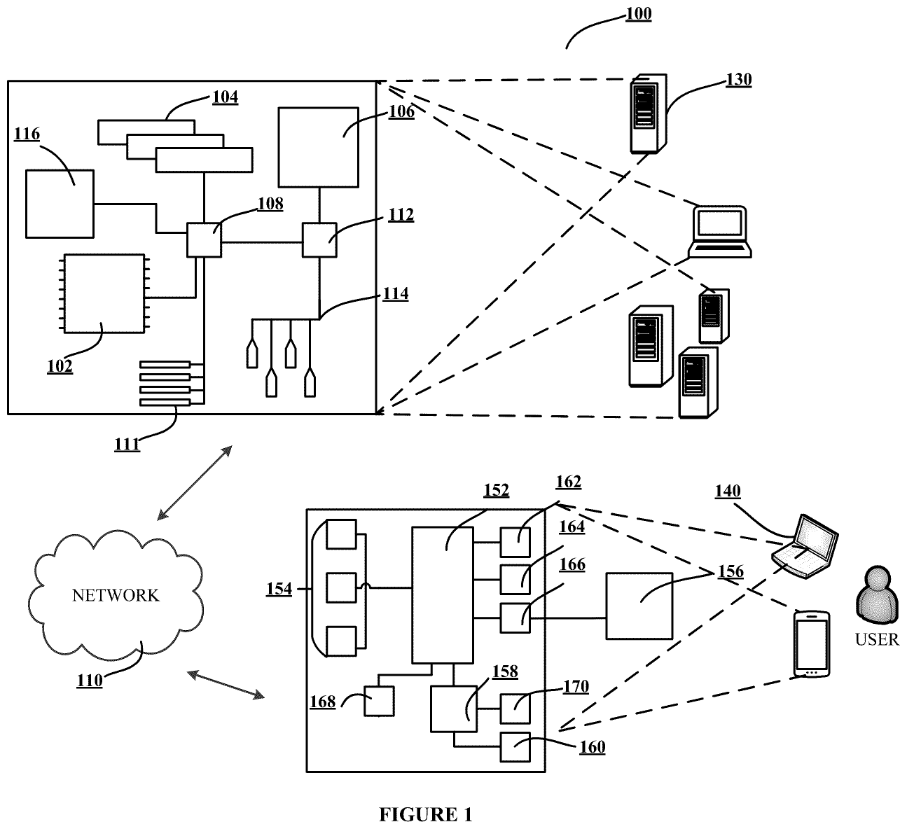

FIG. 1 presents an exemplary block diagram of a system environment 100 for extracting discrete data from a data unit and managing access thereto using electronic digital certificates within a technical environment, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile computing device, a non-mobile computing device, and/or the like. The user may be a person who uses the user input system 140 to access, view modify, interact with, and/or the like information, data, images, video, and/or the like. The user may be a person who uses the user input system 140 to initiate, perform, monitor, and/or the like changes and/or modifications to one or more systems, applications, services, and/or the like. The one or more systems, applications, services, and/or the like may be configured to communicate with the system 130, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

In some embodiments, the system 130 and the user input system 140 may be used to implement processes described herein, including user-side and server-side processes for extracting discrete data from a data unit and managing access thereto using electronic digital certificates, in accordance with an embodiment of the present invention. The system 130 may represent various forms of digital computers, such as laptops, desktops, workstations, personal digital assistants, servers, blade servers, mainframes, automated teller machines, and/or the like. The user input system 140 may represent various forms of devices, such as personal digital assistants, cellular telephones, smartphones, smart glasses, desktops, workstations, automated teller machines, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The memory 104 may store information within the system 130. In some embodiments, the memory 104 may be a volatile memory unit or units, such as volatile random-access memory (RAM) having a cache area for the temporary storage of information. In some embodiments, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

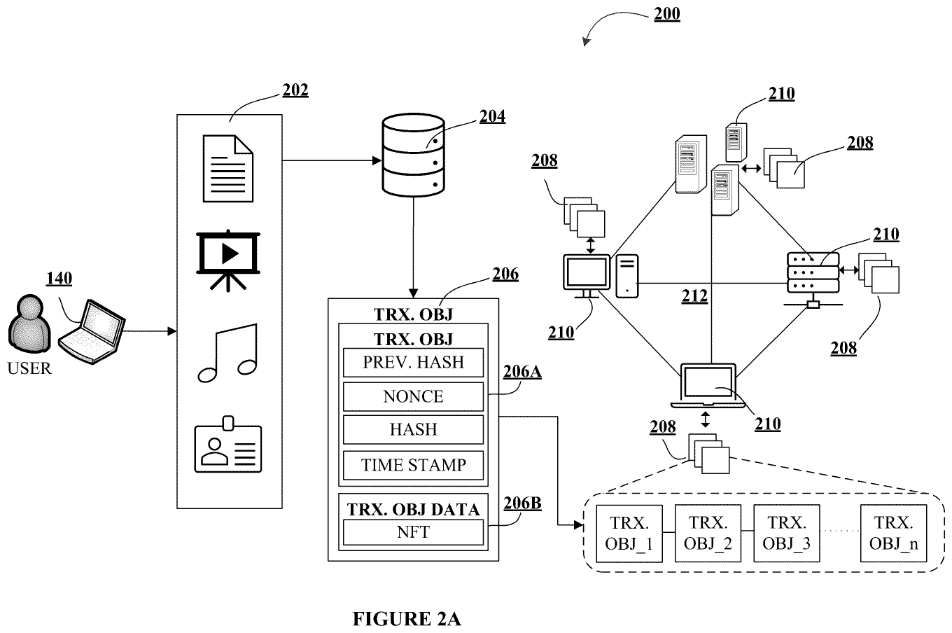

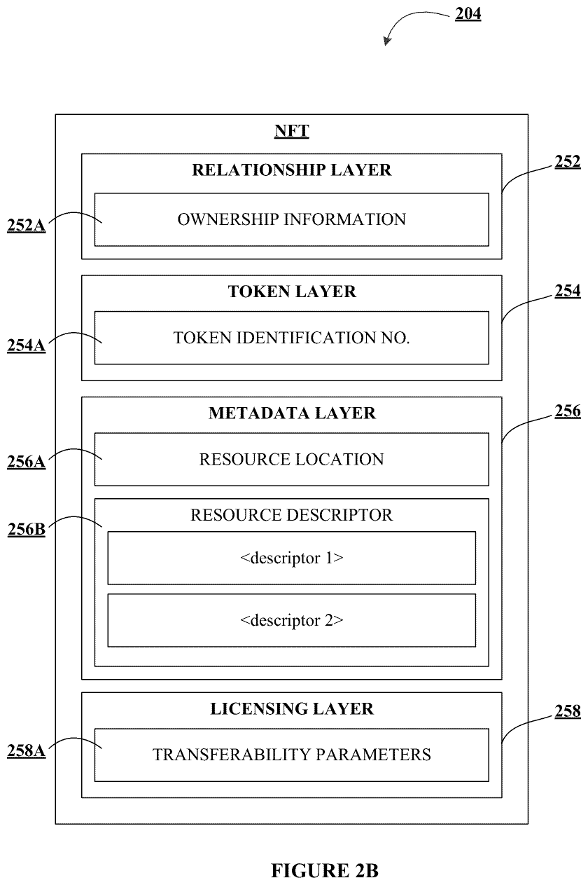

In some embodiments, the system environment 100 may include one or more data unit (e.g., document) intake systems and/or platforms, one or more electronic digital certificate-based orchestrations systems and/or platforms, one or more secure data unit content bifurcation systems and/or apparatuses, one or more electronic digital certificate content segment acquisition and/or orchestrations systems and/or engines, entity systems, entity devices, user devices, and/or the like (e.g., one or more of which may be similar to the system 130 and/or the user input system 140) associated with one or more entities (e.g., businesses, merchants, financial institutions, card management institutions, software and/or hardware development companies, software and/or hardware testing companies, and/or the like). In some embodiments, the one or more data unit (e.g., document) intake systems and/or platforms, one or more electronic digital certificate-based orchestrations systems and/or platforms, one or more secure data unit content bifurcation systems and/or apparatuses, one or more electronic digital certificate content segment acquisition and/or orchestrations systems and/or engines, entity systems, entity devices, user devices, and/or the like may perform one or more of the steps described herein with respect to the process flows described herein with respect to FIGS. 2A, 2B, and 3-8.

FIG. 2A illustrates an exemplary process flow 200 for creating an electronic digital certificate, in accordance with an embodiment of the invention. As shown in FIG. 2A, to create or “mint” an electronic digital certificate, such as an NFT, a user (e.g., NFT owner) may identify, using a user input system 140, resources 202 that the user wishes to mint as an NFT. Typically, NFTs are minted from digital objects that represent both tangible and intangible objects. These resources 202 may include a piece of art, music, collectible, virtual world items, videos, real-world items such as artwork and real estate, other presumed valuable objects, and/or the like. These resources 202 are then digitized into a proper format to produce an NFT 204. The NFT 204 may be a multi-layered documentation that identifies the resources 202 but also evidences various transaction conditions associated therewith, as described in more detail with respect to FIG. 2B.

To record the NFT in a distributed ledger (e.g., a blockchain), a transaction object 206 for the NFT 204 is created. The transaction object 206 may include a transaction header 206A and a transaction object data 206B. The transaction header 206A may include a cryptographic hash of the previous transaction object, a nonce (e.g., a randomly generated 32-bit whole number generated when the transaction object is created), cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process.

As shown in FIG. 2A, the distributed ledger 208 may be maintained on multiple devices (nodes) 210 that are authorized to keep track of the distributed ledger 208. For example, these nodes 210 may be computing devices such as system 130 and user input system 140 (e.g., end-point device(s)). One node 210 may have a complete or partial copy of the entire distributed ledger 208 or set of transactions and/or transaction objects on the distributed ledger 208. Transactions, such as the creation and recordation of an NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary electronic digital certificate in the form of an NFT 204 as a multi-layered documentation of a resource, in accordance with an embodiment of an invention. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, if the NFT 204 is purchased by buyer B1 from a seller S1, the relationship between B1 and S1 as a buyer-seller is recorded in the relationship layer 252. In another example, if the NFT 204 is owned by O1 and the resource itself is stored in a storage facility by storage provider SP1, then the relationship between O1 and SP1 as owner-file storage provider is recorded in the relationship layer 252. The token layer 254 may include a token identification number 254A that is used to identify the NFT 204. The metadata layer 256 may include at least a resource location 256A and a resource descriptor 256B. The resource location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The resource location 256A identifies where the resource 202 is stored. The resource descriptor 256B may include specific information associated with the source itself 202. For example, the resource descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers may be configured as needed without departing from the scope and spirit of the invention.

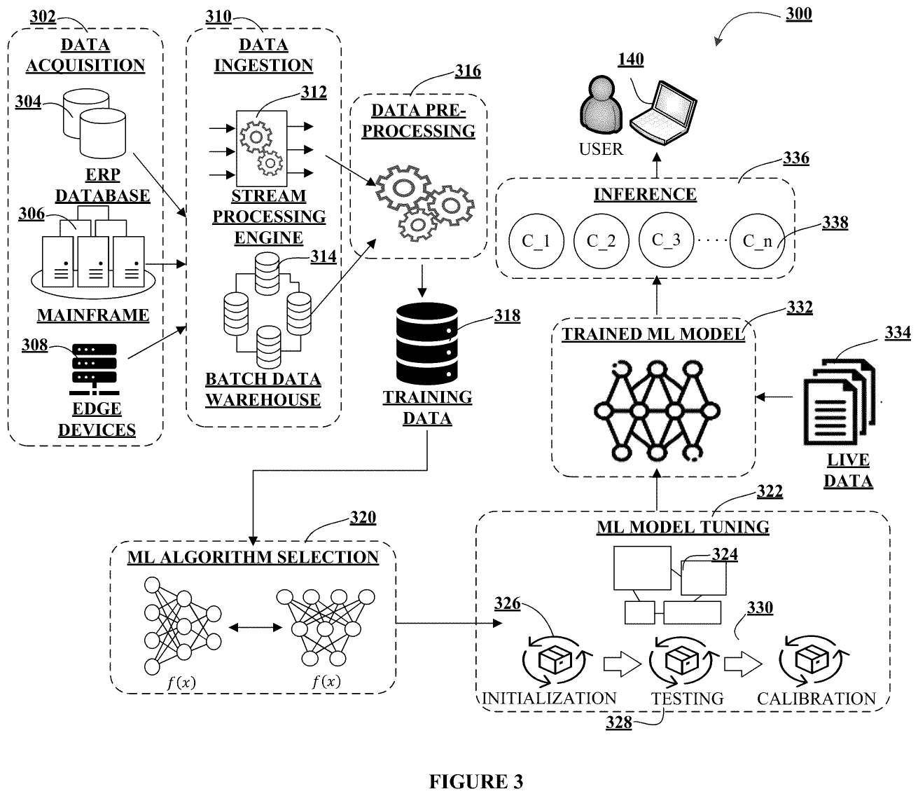

FIG. 3 illustrates an exemplary machine learning (ML) subsystem architecture 300, in accordance with an embodiment of the invention. The machine learning subsystem 300 may include a data acquisition engine 302, a data ingestion engine 310, a data pre-processing engine 316, an ML model tuning engine 322, an inference engine 336, and/or the like.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources 304, 306, and 308 may include Enterprise Resource Planning (ERP) databases that host data related to day-to-day business activities such as accounting, procurement, project management, exposure management, supply chain operations, and/or the like, a mainframe that is often the entity's central data processing center, edge devices that may be any piece of hardware, such as sensors, actuators, gadgets, appliances, machines, and/or the like, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 310, the data may be ingested in real-time, using a stream processing engine 312, in batches using a batch data warehouse 314, and/or a combination of both. The stream processing engine 312 may be used to process a continuous data stream (e.g., data from edge devices), i.e., computing on data directly as the data is received, and filter the incoming data to retain specific portions that are deemed useful by aggregating, analyzing, transforming, and ingesting the data. In some embodiments, the batch data warehouse 314 may collect and transfer data in batches according to scheduled intervals, trigger events, and/or any other ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, and/or format of the data using generalization, normalization, attribute selection, and/or aggregation, data cleaning by filling missing values, smoothing the noisy data, resolving the inconsistency, removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, the training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and/or speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, and/or the like), unsupervised learning (e.g., using an Apriori algorithm, using K-means clustering, and/or the like), semi-supervised learning, reinforcement learning (e.g., using a Q-learning algorithm, using temporal difference learning, and/or the like), and/or any other suitable machine learning model type. Each of these types of machine learning algorithms may implement any of one or more of a regression algorithm (e.g., ordinary least squares, logistic regression, stepwise regression, multivariate adaptive regression splines, locally estimated scatterplot smoothing, and/or the like), an instance-based method (e.g., k-nearest neighbor, learning vector quantization, self-organizing map, and/or the like), a regularization method (e.g., ridge regression, least absolute shrinkage and selection operator, elastic net, and/or the like), a decision tree learning method (e.g., classification and regression tree, iterative dichotomiser 3, C4.5, chi-squared automatic interaction detection, decision stump, random forest, multivariate adaptive regression splines, gradient boosting machines, and/or the like), a Bayesian method (e.g., naïve Bayes, averaged one-dependence estimators, Bayesian belief network, and/or the like), a kernel method (e.g., a support vector machine, a radial basis function, and/or the like), a clustering method (e.g., k-means clustering, expectation maximization, and/or the like), an associated rule learning algorithm (e.g., an Apriori algorithm, an Eclat algorithm, and/or the like), an artificial neural network model (e.g., a Perceptron method, a back-propagation method, a Hopfield network method, a self-organizing map method, a learning vector quantization method, and/or the like), a deep learning algorithm (e.g., a restricted Boltzmann machine, a deep belief network method, a convolution network method, a stacked auto-encoder method, and/or the like), a dimensionality reduction method (e.g., principal component analysis, partial least squares regression, Sammon mapping, multidimensional scaling, projection pursuit, and/or the like), an ensemble method (e.g., boosting, bootstrapped aggregation, AdaBoost, stacked generalization, gradient boosting machine method, random forest method, and/or the like), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm, the value of alpha in a linear algorithm, and/or the like), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 338) live data 334 based on how similar they are to one another to solve exploratory challenges where little is known about the data, provide a description or label (e.g., C_1, C_2 . . . C_n 338) to live data 334, such as in classification, and/or the like. These categorized outputs, groups (clusters), or labels are then presented to the user input system 140. In still other cases, machine learning models that perform regression techniques may use live data 334 to predict or forecast continuous outcomes.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

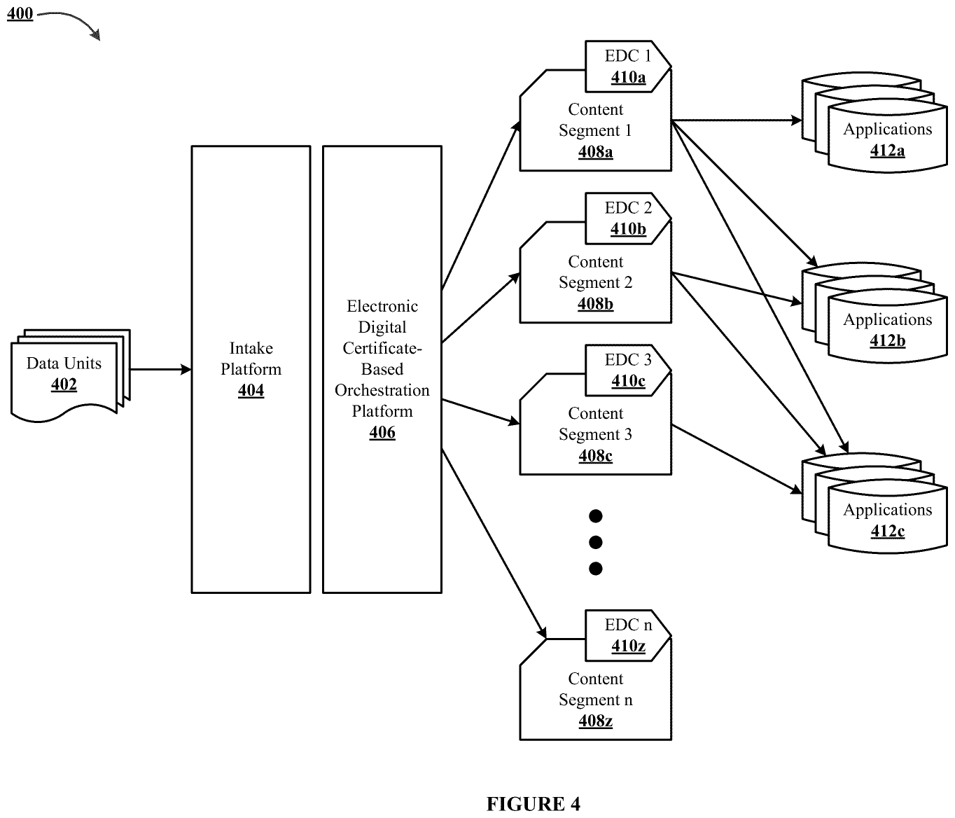

FIG. 4 illustrates an exemplary system flow 400 for extracting discrete data from a data unit and managing access thereto using electronic digital certificates, in accordance with an embodiment of the invention. As shown in FIG. 4, the system flow 400 may include receiving data units 402 (e.g., a plurality of documents) with an intake platform 404. In some embodiments, the data units 402 may be received from one or more input channels (e.g., from facsimile systems, from other systems and/or devices scanning physical documents, from applications executing on other systems and/or devices to generate digital documents, and/or the like). Additionally, or alternatively, the intake platform 404 may include one or more facsimile systems, systems and/or devices for scanning physical documents, applications executing on other systems and/or devices to generate digital documents, and/or the like.

In some embodiments, the data units 402 may include one or more documents associated with a loan application process, such as a loan application, one or more tax documents, one or more paychecks, one or more proof-of-revenue documents, one or more account statements, one or more property appraisals, one or more title check documents, one or more deeds, one or more mortgage documents, one or more personal identification cards, and/or the like. Additionally, or alternatively, the data units 402 may include photographs of the one or more documents, facsimile copies of the one or more documents, scans of the one or more documents, and/or the like. In some embodiments, each of the data units 402 may include content (e.g., discrete data, information, alphanumeric characters, one or more images, and/or the like).

As shown in FIG. 4, the system flow 400 may include identifying, using an electronic digital certificate-based orchestration platform 406, content segments 408a-408z in the data units 402. For example, the system flow 400 may include using a machine learning model (e.g., executing on the electronic digital certificate-based orchestration platform 406) to identify content segments 408a-408z in the data units 402. In some embodiments, the system flow 400 may include using optical character recognition (OCR), natural language processing (NLP), a generative adversarial network (GAN), and/or the like to identify the content segments 408a-408z in the data units 402.

As shown in FIG. 4, the system flow 400 may include generating, using an electronic digital certificate-based orchestration platform 406, electronic digital certificates 410a-410z. In some embodiments, the system flow 400 may include generating an electronic digital certificate for each of the content segments 408a-408z identified in the data units 402. For example, and as shown in FIG. 4, the system flow 400 may include generating electronic digital certificate 1 (EDC 1) 410a for content segment 1 408a, EDC 2 410b for content segment 2 408b, EDC 3 410c for content segment 3 408c, and so on through EDC n 410z for content segment n 408z. In some embodiments, the electronic digital certificates 410a-410z may be generated based on the content segments 408a-408z. For example, the electronic digital certificates 410a-410z may be NFTs generated, created, and/or minted in a manner similar to that described herein with respect to FIGS. 2A and 2B, where the resource used to generate, create, and/or mint each NFT is a content segment of the content segments 408a-408z.

Additionally, or alternatively, the system flow 400 may include associating each of the electronic digital certificates 410a-410z with the content segment of the content segments 408a-408z for which the content segment was generated. For example, and as shown in FIG. 4, the system flow 400 may include generating the EDC 1 410a for the content segment 1 408a and associating the EDC 1 410a with the content segment 1 408a.

As shown in FIG. 4, the system flow 400 may include restricting access, by applications 412a, 412b, and 412c, to the content segments 408a-408z based on the electronic digital certificates 410a-410z. For example, and as shown in FIG. 4, the system flow 400 may include permitting the applications 412a, 412b, and 412c to access the content segment 1 408a based on the EDC 1 410. As another example, and as shown in FIG. 4, the system flow 400 may include permitting the applications 412b and 412c to access the content segment 2 408b and preventing the applications 412a from accessing the content segment 2 408b based on the EDC 2 410b. As yet another example, and as shown in FIG. 4, the system flow 400 may include permitting only the applications 412c to access the content segment 3 408c and preventing the applications 412a and 412b from accessing the content segment 3 408c. In this way, the system flow 400 may restrict access to particular content segments in a data unit.

System flow 400 may include additional embodiments, such as any single embodiment or any combination of embodiments described below and/or in connection with one or more other processes described elsewhere herein. Although FIG. 4 shows example blocks of system flow 400, in some embodiments, system flow 400 may include additional blocks, fewer blocks, different blocks, or differently arranged blocks than those depicted in FIG. 4. Additionally, or alternatively, two or more of the blocks of system flow 400 may be performed in parallel.

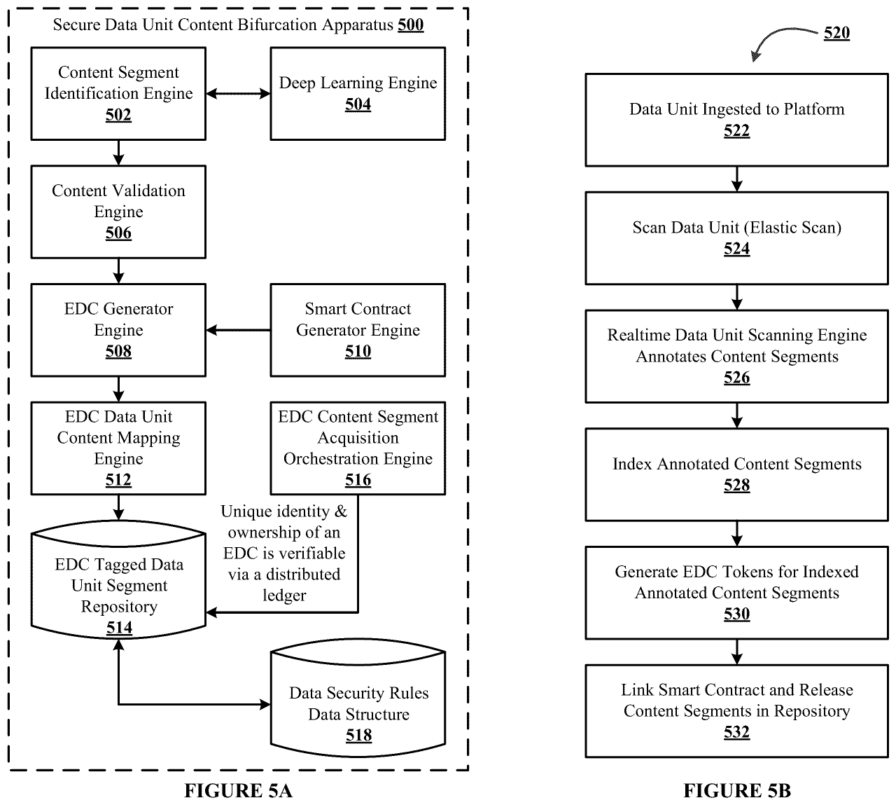

FIG. 5A illustrates an exemplary secure data unit content bifurcation apparatus 500, in accordance with an embodiment of the invention. As shown in FIG. 5A, the secure data unit content bifurcation apparatus 500 may include a content segment identification engine 502, a deep learning engine 504, a content validation engine 506, an electronic digital certificate (EDC) generator engine 508, a smart contract generator engine 510, an EDC data unit content mapping engine 512, an EDC tagged data unit segment repository 514, an EDC content segment acquisition orchestration engine 516, and a data security rules data structure 518.

As shown in FIG. 5A, the content segment identification engine 502 and the deep learning engine 504 may exchange data and/or information. For example, the content segment identification engine 502 may receive a data unit, and the content segment identification engine 502 may, in conjunction with the deep learning engine 504, identify content segments in the data unit. As another example, the content segment identification engine 502 may scan the data unit (e.g., using OCR and/or the like) and provide data associated with the data unit to the deep learning engine 504, and the deep learning engine 504 may process the data from the content segment identification engine 502 using one or more machine learning models to determine boundaries of content segments within the data unit, identify content segments within the data unit, and/or the like. In some embodiments, the deep learning engine 504 may output the results of the processing (e.g., the boundaries of content segments within the data unit, the identified content segments within the data unit, and/or the like) to the content segment identification engine 502, and the content segment identification engine 502 may use the results to identify and/or tag the content segments within the data unit.

As shown in FIG. 5A, the content segment identification engine 502 may output data including the content segments to the content validation engine 506. In some embodiments, the content validation engine 506 analyzes the data including the content segments to validate that the content segments in the data unit were correctly identified. For example, the content validation engine 506 may compare the data including the content segments to previously validated content segments for similar previously analyzed data units to determine whether the content segments in the data unit were correctly identified.

As shown in FIG. 5A, the content validation engine 506 may, after validating the content segments, provide data including the validated content segments to the EDC generator engine 508. In some embodiments, the EDC generator engine 508 may generate, for each of the content segments received from the content validation engine 506, an electronic digital certificate. Additionally, or alternatively, the EDC generator engine 508 may generate the electronic digital certificates based on the content segments. For example, the electronic digital certificates may be NFTs, and the EDC generator engine 508 may generate, create, and/or mint the NFTs in a manner similar to that described herein with respect to FIGS. 2A and 2B, where the resource used to generate, create, and/or mint each NFT is a content segment of the content segments.

A shown in FIG. 5A, the EDC generator engine 508 may receive data from the smart contract generator engine 510. In some embodiments, the smart contract generator engine 510 may generate, for each electronic digital certificate, a smart contract, where the smart contract governs whether one or more applications are permitted to access the content segment associated with the electronic digital certificate. For example, the smart contract generator engine 510 may generate smart contracts based on a data structure including data security rules, such as the data security rules data structure 518, and data from the content segment identification engine 502, the deep learning engine, and/or the like (e.g., data including information about the content, context, and/or the like of the content segments). In some embodiments, the EDC generator engine 508 may link each smart contract from the smart contract generator engine 510 to its corresponding electronic digital certificate.

As shown in FIG. 5A, the EDC generator engine 508 may provide data including the electronic digital certificates and/or the linked smart contracts to the EDC data unit content mapping engine 512. In some embodiments, the EDC data unit content mapping engine 512 may map the electronic digital certificates and/or the linked smart contracts to the content segments within the data unit. For example, the EDC data unit content mapping engine 512 may associate an electronic digital certificate and/or linked smart contract to a content segment for which the electronic digital certificate was generated (e.g., by the EDC generator engine 508).

As shown in FIG. 5A, the EDC data unit content mapping engine 512 may provide data including the data units with the electronic digital certificates and/or the linked smart contracts mapped to the content segments within the data units to the EDC tagged data unit segment repository 514. In some embodiments, the EDC tagged data unit segment repository 514 may include a data structure for storing and providing access to the content segments and/or the data units.

As shown in FIG. 5A, the EDC tagged data unit segment repository 514 may provide and/or receive data and/or otherwise communicate with the data security rules data structure 518. In some embodiments, the EDC tagged data unit segment repository 514 may exchange data including information regarding access to the data units and/or content segments. For example, the data security rules data structure 518 may store the smart contracts, may determine whether the smart contracts comply with and/or correspond to predetermined (e.g., by an entity, a user, and/or the like) data security rules, and/or the like.

As shown in FIG. 5A, the EDC content segment acquisition orchestration engine 516 may access the EDC tagged data unit segment repository 514 to provide data units and/or content segments to one or more applications. In some embodiments, and as shown in FIG. 5A, the unique identity and ownership of an electronic digital certificate may be verifiable via a distributed ledger. For example, one or more components of the secure data unit content bifurcation apparatus 500 may record ownership of an electronic digital certificate associated with a content segment on a distributed ledger, where the recorded ownership corresponds to the smart contract determining whether one or more applications are permitted to access the content segment associated with the electronic digital certificate. In some embodiments, qualifications for accessing a content segment may include ownership of an electronic digital certificate associated with the content segment and/or the like. The EDC content segment acquisition orchestration engine 516 may determine whether an application is permitted to access a content segment based on the distributed ledger, and then either grant or deny access to the application. Furthermore, in some embodiments, the EDC content segment acquisition orchestration engine 516 may identify the content segment based on the electronic digital certificate and permit the application to access the content segment.

The secure data unit content bifurcation apparatus 500 may include additional embodiments, such as any single embodiment or any combination of embodiments described below and/or in connection with one or more other processes described elsewhere herein. Although FIG. 5A shows example blocks of the secure data unit content bifurcation apparatus 500, in some embodiments, the secure data unit content bifurcation apparatus 500 may include additional blocks, fewer blocks, different blocks, or differently arranged blocks than those depicted in FIG. 5A. Additionally, or alternatively, two or more of the blocks of the secure data unit content bifurcation apparatus 500 may be performed in parallel.

FIG. 5B illustrates an exemplary process flow 520 for extracting discrete data from a data unit and managing access thereto using electronic digital certificates, in accordance with an embodiment of the invention. As shown in FIG. 5B, the process flow 520 may include ingesting a data unit into a platform 522 (e.g., similar to the intake platform 404 shown and described herein with respect to FIG. 4). In some embodiments, ingesting the data unit into the platform may include receiving the data unit from one or more of a plurality of input channels (e.g., from facsimile systems, from other systems and/or devices scanning physical documents, from applications executing on other systems and/or devices to generate digital documents, and/or the like).

As shown in FIG. 5B, the process flow 520 may include scanning the data unit 524. For example, and as shown in FIG. 5B, scanning the data unit 524 may include performing an elastic scan of the data unit. In some embodiments, scanning the data unit 524 may include performing one or more different types of scans of the data unit, such as schema-less scanning, image-based scanning, and/or the like.

As shown in FIG. 5B, the process flow 520 may include annotating, using a real-time data unit scanning engine, content segments 526. In some embodiments, annotating the content segments may include identifying the content segments in the data unit and/or analyzing the data unit and/or the content segments using one or more machine learning models and/or deep learning engines in a manner similar to that described herein with respect to FIGS. 3, 4, 5A, and 6-8.

As shown in FIG. 5B, the process flow 520 may include indexing the annotated content segments 528. In some embodiments, indexing the annotated content segments 528 may be performed based on data and/or information determined when annotating, using the real-time data unit scanning engine, the content segments 526.

As shown in FIG. 5B, the process flow 520 may include generating EDC tokens for the indexed annotated content segments 530. For example, the process flow 520 may include generating an EDC token for each of the indexed annotated content segments. In some embodiments, generating the EDC token may include generating an NFT token for each content segment. For example, the process flow 520 may include generating, for each content segment in the data unit, an NFT based on the content segment in a manner similar to that described herein with respect to FIGS. 2A, 2B, 4, 5A, and 6-8.

As shown in FIG. 5B, the process flow 520 may include linking a smart contract to the EDC tokens and the content segments and releasing the content segments in a repository 532. For example, the repository may be similar to the EDC tagged data unit segment repository 514 as shown and described herein with respect to FIG. 5A. In some embodiments, the process flow 520 may include generating the smart contract that is linked to the EDC token and the content segments.

Process flow 520 may include additional embodiments, such as any single embodiment or any combination of embodiments described below and/or in connection with one or more other processes described elsewhere herein. Although FIG. 5B shows example blocks of process flow 520, in some embodiments, process flow 520 may include additional blocks, fewer blocks, different blocks, or differently arranged blocks than those depicted in FIG. 5B. Additionally, or alternatively, two or more of the blocks of process flow 520 may be performed in parallel.

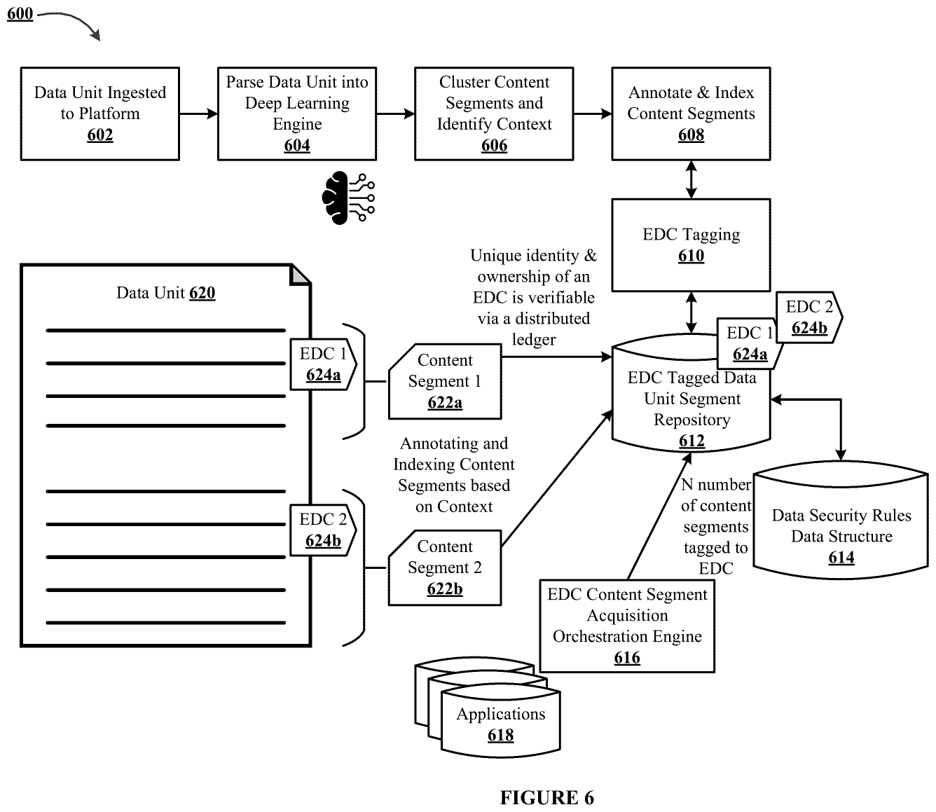

FIG. 6 illustrates an exemplary process flow 600 for extracting discrete data from a data unit 620 and managing access thereto using electronic digital certificates, in accordance with an embodiment of the invention. As shown in FIG. 6, the process flow 600 may include ingesting the data unit 620 into a platform 602 (e.g., similar to the intake platform 404 shown and described herein with respect to FIG. 4). In some embodiments, ingesting the data unit into the platform may include receiving the data unit from one or more of a plurality of input channels (e.g., from facsimile systems, from other systems and/or devices scanning physical documents, from applications executing on other systems and/or devices to generate digital documents, and/or the like).

As shown in FIG. 6, the process flow 600 may include parsing the data unit into a deep learning engine 604. For example, the process flow 600 may include parsing the data unit into a deep learning engine in a manner similar to that described herein with respect to the content segment identification engine 502 and the deep learning engine 504 shown and described herein with respect to FIGS. 5A and 5B.

As shown in FIG. 6, the process flow 600 may include clustering content segments and identifying context 606. In some embodiments, the process flow 600 may include using a system similar to the secure data unit content bifurcation apparatus 500 described herein with respect to FIG. 5A to cluster content segments and identify the context of the segments. For example, the process flow 600 may include using a content segment identification engine and a deep learning engine to cluster content segments and identify the context of the segments.

As shown in FIG. 6, the process flow 600 may include annotating and indexing the content segments 608. For example, the process flow 600 may include using one or more machine learning models and/or deep learning engines to annotate and index the content segments. As another example, and as shown in FIG. 6, the process flow 600 may include identifying content segment 1 622a and content segment 2 622b in the data unit 620 and annotating and indexing the content segments based on context.

As shown in FIG. 6, the process flow 600 may include tagging the content segments with electronic digital certificates 610. In some embodiments, the process flow 600 may include generating an electronic digital certificate for each of the content segments. For example, and as shown in FIG. 6, the process flow 600 may include generating EDC 1 624a for content segment 1 622a and tagging content segment 1 622a with EDC 1 624a as well as generating EDC2 624b for content segment 2 622b and tagging content segment 2 622b with EDC2 624b. In some embodiments, the electronic digital certificates may be NFTs. For example, the process flow 600 may include generating, for each content segment in the data unit 620, an NFT based on the content segment in a manner similar to that described herein with respect to FIGS. 2A, 2B, 4, 5A, and 7-8 and tagging the content segment with the NFT for which the NFT was generated. Additionally, or alternatively, and as shown in FIG. 6, the unique identity and ownership of each EDC may be recorded on a distributed ledger such that the unique identity and ownership of each EDC is verifiable via the distributed ledger. In some embodiments, and as also shown in FIG. 6, multiple content segments (i.e., N number of content segments) may be tagged with one electronic digital certificate.

As shown in FIG. 6, the process flow 600 may include storing the EDC tagged content segments from the data unit in a repository 612. As also shown in FIG. 6, the process flow 600 may include applying one or more data security rules stored in a data security rules data structure to the EDC tagged content segments 614. For example, the process flow 600 may include implementing the data security rules in the data security rules data structure using the electronic digital certificates such that permission to access the content segments of the data unit 620 is restricted in accordance with the data security rules.

As shown in FIG. 6, the process flow 600 may include managing the access of applications 618 to the content segments using the EDC segment acquisition orchestration engine 616. For example, an application, of the applications 618, may request access to one or more content segments of the data unit 620. The EDC segment acquisition orchestration engine 616 may determine, based on the ownership, recorded on the distributed ledger, of electronic digital certificates corresponding to the one or more content segments, whether the application is permitted to access the one or more content segments. Based on determining that the application is permitted to access the one or more content segments, the EDC segment acquisition orchestration engine 616 may provide the application with access to the one or more content segments. Based on determining that the application is not permitted to access the one or more content segments, the EDC segment acquisition orchestration engine 616 may prevent the application from accessing the one or more content segments.

Process flow 600 may include additional embodiments, such as any single embodiment or any combination of embodiments described below and/or in connection with one or more other processes described elsewhere herein. Although FIG. 6 shows example blocks of process flow 600, in some embodiments, process flow 600 may include additional blocks, fewer blocks, different blocks, or differently arranged blocks than those depicted in FIG. 6. Additionally, or alternatively, two or more of the blocks of process flow 600 may be performed in parallel.

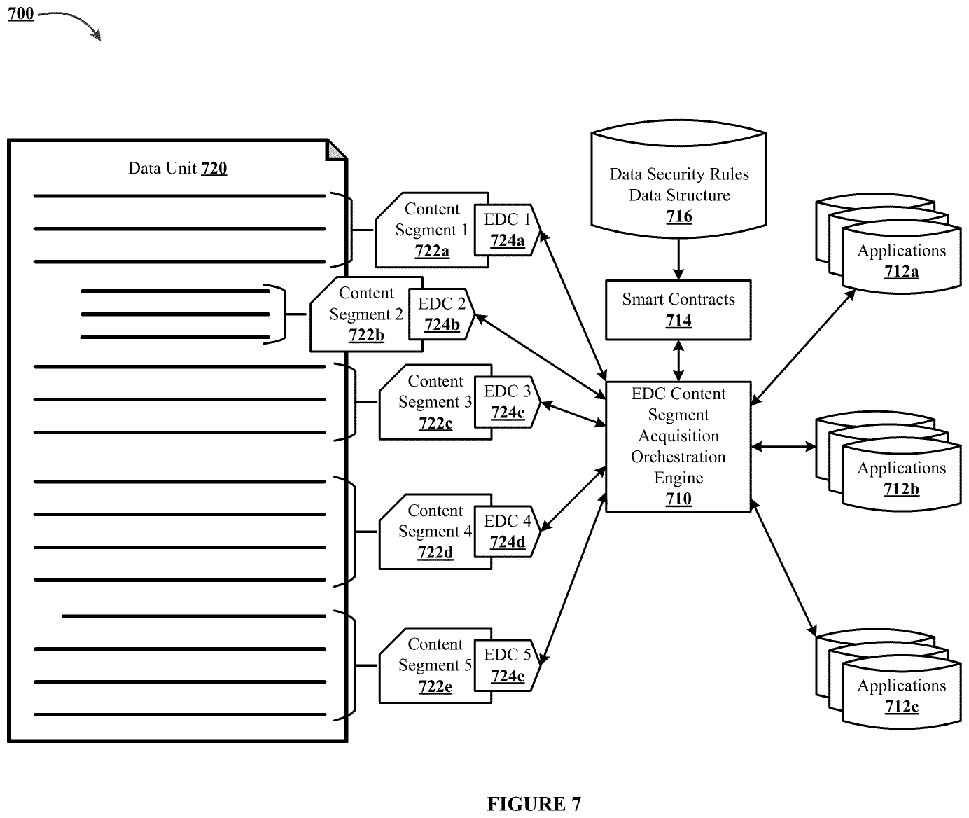

FIG. 7 illustrates an exemplary process flow 700 for managing access to discrete data from data units using electronic digital certificates, in accordance with an embodiment of the invention. As shown in FIG. 7, the process flow 700 includes an EDC content segment acquisition orchestration engine 710, applications 712a, 712b, and 712c, smart contracts 714, a data security rules data structure 716, a data unit 720, a plurality of content segments 722a, 722b, 722c, 722d, and 722e, and a plurality of electronic digital certificates (EDCs) 724a, 724b, 724c, 724d, and 724e.

As shown in FIG. 7, the data unit 720 may include the plurality of content segments 722a, 722b, 722c, 722d, and 722e. In some embodiments, a system (e.g., similar to one or more of the platforms, apparatuses, engines, and/or the like described herein with respect to FIGS. 1, 2A, 2B, and/or 3-6) may have identified the plurality of content segments 722a, 722b, 722c, 722d, and 722e in the data unit 720, generated the plurality of EDCs 724a, 724b, 724c, 724d, and 724e based on the plurality of content segments 722a, 722b, 722c, 722d, and 722e, and associated, tagged, and/or the like each of the plurality of content segments 722a, 722b, 722c, 722d, and 722e with its corresponding EDC of the plurality of EDCs 724a, 724b, 724c, 724d, and 724e (e.g., in a manner similar to that described herein with respect to FIGS. 4, 5A, 5B, 6, and/or 8). For example, and as shown in FIG. 7, content segment 1 722a, content segment 2 722b, content segment 3 722c, content segment 4 722d, and content segment 5 722e may be respectively associated, tagged, and/or the like with EDC 1 724a, EDC 2 724b, EDC 3 724c, EDC 4 724d, and EDC 5 724e.

As shown in FIG. 7, the process flow 700 may include generating, creating, maintaining, and/or managing the smart contracts 714 using the data security rules data structure 716. In some embodiments, the process flow 700 may include generating, creating, maintaining, and/or managing the smart contracts 714 based on one or more data security rules stored in a data security rules data structure 716. For example, the process flow 700 may include implementing the data security rules in the data security rules data structure 716 using the smart contracts 714 and the plurality of EDCs 724a, 724b, 724c, 724d, and 724e such that permission to access the content segments of the data unit 720 is restricted in accordance with the data security rules. In some embodiments, the process flow 700 may include storing the smart contracts 714 in a smart contracts data structure (e.g., a smart contracts database, a smart contracts table, and/or the like). Additionally, or alternatively, the process flow 700 may include storing the smart contracts 714 on a distributed ledger.

As shown in FIG. 7, the process flow 700 may include managing, using the EDC content segment acquisition orchestration engine 710, access to the plurality of content segments 722a, 722b, 722c, 722d, and 722e of the data unit 720 using the plurality of EDCs 724a, 724b, 724c, 724d, and 724e and the smart contracts 714 for the applications 712a, 712b, and 712c. For example, the process flow 700 may include receiving a request from the application 712a to access the data unit 720. The process flow 700 may include determining, with the EDC content segment acquisition orchestration engine 710 and using the smart contracts 714 and ownership of the plurality of EDCs 724a, 724b, 724c, 724d, and 724e recorded on a distributed ledger, whether the application 712a is permitted to access each of the plurality of content segments 722a, 722b, 722c, 722d, and 722e of the data unit 720. As an example, the process flow 700 may include determining that the application 712a is permitted to access content segment 1 722a, content segment 3 722c, and content segment 5 722e but not content segment 2 722b or content segment 4 722d. Rather than permitting the application 712a to access the entire data unit 720 (i.e., all of the content segments 722a, 722b, 722c, 722d, and 722e), the process flow 700 may include permitting the application 712a to access content segment 1 722a, content segment 3 722c, and content segment 5 722e and preventing the application 712a from accessing content segment 2 722b and content segment 4 722d. Such a process may be carried out with respect to each request from a plurality of applications (e.g., more than the three applications 712a, 712b, and 712c shown in FIG. 7) to access a plurality of data units (e.g., more than the one data unit 720 shown in FIG. 7).

Process flow 700 may include additional embodiments, such as any single embodiment or any combination of embodiments described below and/or in connection with one or more other processes described elsewhere herein. Although FIG. 7 shows example blocks of process flow 700, in some embodiments, process flow 700 may include additional blocks, fewer blocks, different blocks, or differently arranged blocks than those depicted in FIG. 7. Additionally, or alternatively, two or more of the blocks of process flow 700 may be performed in parallel.

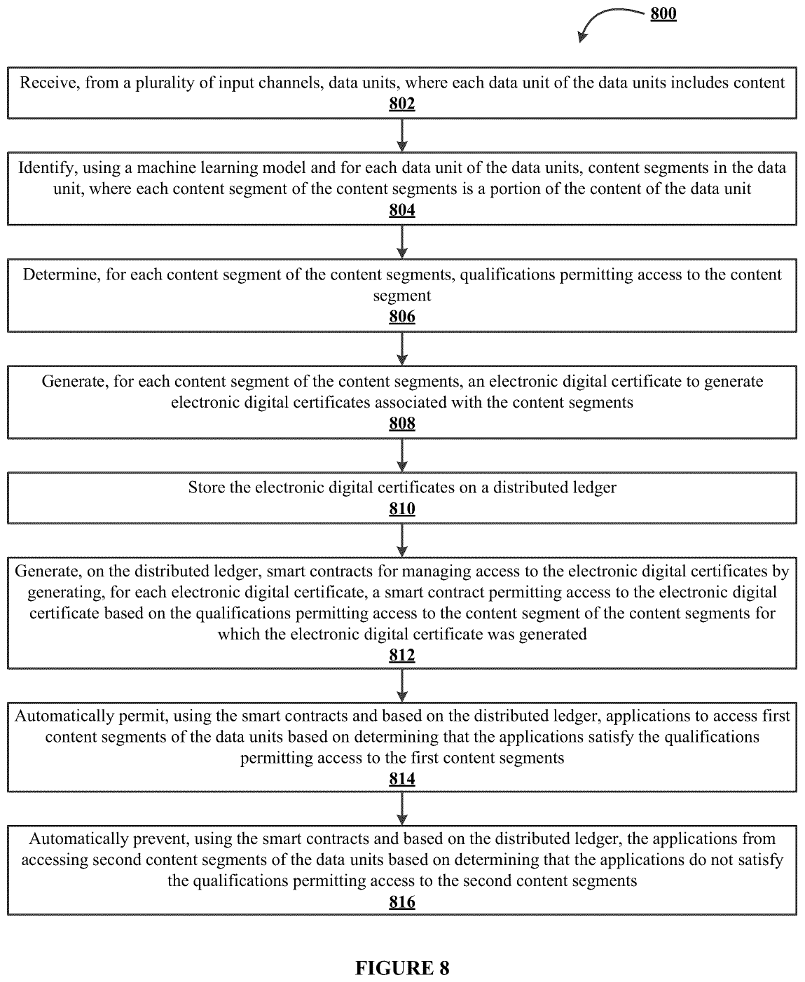

FIG. 8 illustrates an exemplary process flow 800 for extracting discrete data from a data unit and managing access thereto using electronic digital certificates, in accordance with an embodiment of the invention. In some embodiments, one or more systems for extracting discrete data from a data unit and managing access thereto using electronic digital certificates, such as a data unit (e.g., document) intake systems and/or platforms, one or more electronic digital certificate-based orchestrations systems and/or platforms, one or more secure data unit content bifurcation systems and/or apparatuses, one or more electronic digital certificate content segment acquisition and/or orchestrations systems and/or engines, entity systems, entity devices, user devices, and/or the like (e.g., similar to one or more of the systems described herein with respect to FIGS. 1, 2A, 2B, and 3-7) associated with one or more entities (e.g., businesses, merchants, financial institutions, card management institutions, software and/or hardware development companies, software and/or hardware testing companies, and/or the like), may perform one or more of the steps of process flow 800.

As shown in block 802, the process flow 800 may include receiving, from a plurality of input channels, data units, where each data unit of the data units includes content. For example, a system for extracting discrete data from a data unit and managing access thereto using electronic digital certificates may receive data units from a plurality of input channels. In some embodiments, each data unit of the data units may include content (e.g., information, alphanumeric characters, one or more images, and/or the like).

As shown in block 804, the process flow 800 may include identifying, using a machine learning model and for each data unit of the data units, content segments (e.g., discrete data) in the data unit, where each content segment of the content segments is a portion of the content of the data unit. For example, a system for extracting discrete data from a data unit and managing access thereto using electronic digital certificates may identify, using a machine learning model and for each data unit of the data units, content segments in the data unit. In some embodiments, each content segment of the content segments may include and/or be a portion of the content of the data unit.

As shown in block 806, the process flow 800 may include determining, for each content segment of the content segments, qualifications permitting access to the content segment. For example, a system for extracting discrete data from a data unit and managing access thereto using electronic digital certificates may determine, for each content segment of the content segments, qualifications permitting access to the content segment.

As shown in block 808, the process flow 800 may include generating, for each content segment of the content segments, an electronic digital certificate to generate electronic digital certificates associated with the content segments. For example, a system for extracting discrete data from a data unit and managing access thereto using electronic digital certificates may generate, for each content segment of the content segments, an electronic digital certificate to generate electronic digital certificates associated with the content segments.

As shown in block 810, the process flow 800 may include storing the electronic digital certificates on a distributed ledger. For example, a system for extracting discrete data from a data unit and managing access thereto using electronic digital certificates may store the electronic digital certificates on a distributed ledger.

As shown in block 812, the process flow 800 may include generating, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated. For example, a system for extracting discrete data from a data unit and managing access thereto using electronic digital certificates may generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated.

As shown in block 814, the process flow 800 may include automatically permitting, using the smart contracts and based on the distributed ledger, applications to access first content segments of the data units based on determining that the applications satisfy the qualifications permitting access to the first content segments. For example, a system for extracting discrete data from a data unit and managing access thereto using electronic digital certificates may automatically permit, using the smart contracts and based on the distributed ledger, applications to access first content segments of the data units based on determining that the applications satisfy the qualifications permitting access to the first content segments.

As shown in block 816, the process flow 800 may include automatically preventing, using the smart contracts and based on the distributed ledger, the applications from accessing second content segments of the data units based on determining that the applications do not satisfy the qualifications permitting access to the second content segments. For example, a system for extracting discrete data from a data unit and managing access thereto using electronic digital certificates may automatically prevent, using the smart contracts and based on the distributed ledger, the applications from accessing second content segments of the data units based on determining that the applications do not satisfy the qualifications permitting access to the second content segments.

Process flow 800 may include additional embodiments, such as any single embodiment or any combination of embodiments described below and/or in connection with one or more other processes described elsewhere herein.

In a first embodiment, the process flow 800 may include receiving, from an application having attributes, a request to access a first data unit of the data units, determining, using the smart contracts and based on the attributes of the application, a first content segment of the first data unit the application is permitted to access and a second content segment of the first data unit the application is not permitted to access, and/or providing, to the application, access to the first content segment while preventing the application from accessing the second content segment.

In a second embodiment alone or in combination with the first embodiment, for each data unit of the data units, each content segment of the content segments may include a field of the data unit and data in the field.

In a third embodiment alone or in combination with any of the first through second embodiments, the process flow 800 may include, when determining the qualifications permitting access to the content segment, determining the qualifications based on a data security rule database.

In a fourth embodiment alone or in combination with any of the first through third embodiments, the process flow 800 may include, when determining the qualifications permitting access to the content segment, determining the qualifications based on characteristics of the content segment, where the characteristics include whether the content segment includes personally identifiable information, whether the content segment includes confidential information, one or more uses of the content segment, a type of data in the content segment, a type of a data unit containing the content segment, and/or the like.

In a fifth embodiment alone or in combination with any of the first through fourth embodiments, the machine learning model may be a first machine learning model, and the process flow 800 may include, when determining the qualifications permitting access to the content segment, determining the qualifications using a second machine learning model.

In a sixth embodiment alone or in combination with any of the first through fifth embodiments, the process flow 800 may include, when determining qualifications, determining, for a third content segment of the content segments, a first qualification permitting access to the third content segment and a second qualification permitting access to the third content segment and, when generating the smart contracts, generating, for a third electronic digital certificate generated for the third content segment, a third smart contract permitting access to the third electronic digital certificate based on the first qualification, and generating, for the third electronic digital certificate, a fourth smart contract permitting access to the third electronic digital certificate based on the second qualification.

In a seventh embodiment alone or in combination with any of the first through sixth embodiments, the process flow 800 may include storing the smart contracts in a smart contracts database.

In an eighth embodiment alone or in combination with any of the first through seventh embodiments, the process flow 800 may include storing the smart contracts on the distributed ledger.

In a ninth embodiment alone or in combination with any of the first through eighth embodiments, the process flow 800 may include, when generating the electronic digital certificates, generating, for each content segment of the content segments, the electronic digital certificate based on the content segment.

In a tenth embodiment alone or in combination with any of the first through ninth embodiments, the machine learning model may be a first machine learning model, and the process flow 800 may include determining, using a second machine learning model, that a first data unit is valid for a first time period, where the first data unit includes a first plurality of content segments, and, when generating the smart contracts, generate, for a first plurality of electronic digital certificates generated for the first plurality of content segments, first smart contracts to only permit access to the first plurality of electronic digital certificates during the first time period.

In an eleventh embodiment alone or in combination with any of the first through tenth embodiments, the machine learning model may be a first machine learning model, and the process flow 800 may include, determining, using a second machine learning model, that a first data unit is valid for a first time period, where the first data unit includes a first plurality of content segments, and recording, after the first time period and on the distributed ledger, a null set as owner of first electronic digital certificates generated for the first plurality of content segments to prevent access to the first plurality of content segments.

In a twelfth embodiment alone or in combination with any of the first through eleventh embodiments, the process flow 800 may include receiving, from a printing device, a request to print a first data unit including a first content segment and a second content segment, where the request is associated with a user, determining, using the smart contracts and based on the distributed ledger, whether the user is permitted to access the first content segment, determining, using the smart contracts and based on the distributed ledger, whether the user is permitted to access the second content segment, and providing, to the printing device, in response to determining that the user is permitted to access the first content segment, and in response to determining that the user is not permitted to access the second content segment, a modified version of the first data unit for printing, where the modified version includes the first content segment and does not include the second content segment.

In a thirteenth embodiment alone or in combination with any of the first through twelfth embodiments, the process flow 800 may include initiating, with a scanning device and in response to input from a user, a scanning operation of a first data unit, identifying, during the scanning operation and using the machine learning model, a first content segment and a second content segment in the first data unit, determining, during the scanning operation, using the smart contracts, and based on the distributed ledger, whether the user is permitted to access the first content segment, determining, during the scanning operation, using the smart contracts, and based on the distributed ledger, whether the user is permitted to access the second content segment, and generating, with the scanning device, in response to determining that the user is permitted to access the first content segment, and in response to determining that the user is not permitted to access the second content segment, a modified scan of the first data unit, where the modified scan includes the first content segment and does not include the second content segment.

Although FIG. 8 shows example blocks of process flow 800, in some embodiments, process flow 800 may include additional blocks, fewer blocks, different blocks, or differently arranged blocks than those depicted in FIG. 8. Additionally, or alternatively, two or more of the blocks of process flow 800 may be performed in parallel.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A system for extracting discrete data from a data unit and managing access thereto using electronic digital certificates, the system comprising:
at least one processing device; and
at least one non-transitory storage device comprising computer-executable program code that, when executed by the at least one processing device, causes the at least one processing device to:
receive, from a plurality of input channels, data units, wherein each data unit of the data units comprises content;
identify, using a machine learning model and for each data unit of the data units, content segments in the data unit, wherein each content segment of the content segments is a portion of the content of the data unit;
determine, for each content segment of the content segments, qualifications permitting access to the content segment;
generate, for each content segment of the content segments, an electronic digital certificate to generate electronic digital certificates associated with the content segments;
store the electronic digital certificates on a distributed ledger;
generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated;
automatically permit, using the smart contracts and based on the distributed ledger, applications to access first content segments of the data units based on determining that the applications satisfy the qualifications permitting access to the first content segments; and
automatically prevent, using the smart contracts and based on the distributed ledger, the applications from accessing second content segments of the data units based on determining that the applications do not satisfy the qualifications permitting access to the second content segments.

2. The system of claim 1, wherein the at least one non-transitory storage device comprises computer-executable program code that, when executed by the at least one processing device, causes the at least one processing device to:
receive, from an application having attributes, a request to access a first data unit of the data units;
determine, using the smart contracts and based on the attributes of the application, a first content segment of the first data unit the application is permitted to access and a second content segment of the first data unit the application is not permitted to access; and
provide, to the application, access to the first content segment while preventing the application from accessing the second content segment.

3. The system of claim 1, wherein, for each data unit of the data units, each content segment of the content segments comprises a field of the data unit and data in the field.

4. The system of claim 1, wherein the at least one non-transitory storage device comprises computer-executable program code that, when executed by the at least one processing device, causes the at least one processing device to, when determining the qualifications permitting access to the content segment, determine the qualifications based on a data security rule database.

5. The system of claim 1, wherein the at least one non-transitory storage device comprises computer-executable program code that, when executed by the at least one processing device, causes the at least one processing device to, when determining the qualifications permitting access to the content segment, determine the qualifications based on characteristics of the content segment, wherein the characteristics comprise at least one of:
whether the content segment comprises personally identifiable information;
whether the content segment comprises confidential information;
one or more uses of the content segment;
a type of data in the content segment; or
a type of a data unit containing the content segment.

6. The system of claim 1, wherein the machine learning model is a first machine learning model, and wherein the at least one non-transitory storage device comprises computer-executable program code that, when executed by the at least one processing device, causes the at least one processing device to, when determining the qualifications permitting access to the content segment, determine the qualifications using a second machine learning model.

7. The system of claim 1, wherein the at least one non-transitory storage device comprises computer-executable program code that, when executed by the at least one processing device, causes the at least one processing device to:
when determining qualifications, determine, for a third content segment of the content segments, a first qualification permitting access to the third content segment and a second qualification permitting access to the third content segment; and
when generating the smart contracts:
generate, for a third electronic digital certificate generated for the third content segment, a third smart contract permitting access to the third electronic digital certificate based on the first qualification; and
generate, for the third electronic digital certificate, a fourth smart contract permitting access to the third electronic digital certificate based on the second qualification.

8. The system of claim 1, wherein the at least one non-transitory storage device comprises computer-executable program code that, when executed by the at least one processing device, causes the at least one processing device to store the smart contracts in a smart contracts database.

9. The system of claim 1, wherein the at least one non-transitory storage device comprises computer-executable program code that, when executed by the at least one processing device, causes the at least one processing device to store the smart contracts on the distributed ledger.

10. The system of claim 1, wherein the at least one non-transitory storage device comprises computer-executable program code that, when executed by the at least one processing device, causes the at least one processing device to, when generating the electronic digital certificates, generate, for each content segment of the content segments, the electronic digital certificate based on the content segment.

11. The system of claim 1, wherein the machine learning model is a first machine learning model, and wherein the at least one non-transitory storage device comprises computer-executable program code that, when executed by the at least one processing device, causes the at least one processing device to:
determine, using a second machine learning model, that a first data unit is valid for a first time period, wherein the first data unit comprises a first plurality of content segments; and
when generating the smart contracts, generate, for a first plurality of electronic digital certificates generated for the first plurality of content segments, first smart contracts to only permit access to the first plurality of electronic digital certificates during the first time period.

12. The system of claim 1, wherein the machine learning model is a first machine learning model, and wherein the at least one non-transitory storage device comprises computer-executable program code that, when executed by the at least one processing device, causes the at least one processing device to:
determine, using a second machine learning model, that a first data unit is valid for a first time period, wherein the first data unit comprises a first plurality of content segments; and
record, after the first time period and on the distributed ledger, a null set as owner of first electronic digital certificates generated for the first plurality of content segments to prevent access to the first plurality of content segments.

13. The system of claim 1, wherein the at least one non-transitory storage device comprises computer-executable program code that, when executed by the at least one processing device, causes the at least one processing device to:
receive, from a printing device, a request to print a first data unit comprising a first content segment and a second content segment, wherein the request is associated with a user;
determine, using the smart contracts and based on the distributed ledger, whether the user is permitted to access the first content segment;
determine, using the smart contracts and based on the distributed ledger, whether the user is permitted to access the second content segment; and
provide, to the printing device, in response to determining that the user is permitted to access the first content segment, and in response to determining that the user is not permitted to access the second content segment, a modified version of the first data unit for printing, wherein the modified version comprises the first content segment and does not comprise the second content segment.

14. The system of claim 1, wherein the at least one non-transitory storage device comprises computer-executable program code that, when executed by the at least one processing device, causes the at least one processing device to:
initiate, with a scanning device and in response to input from a user, a scanning operation of a first data unit;
identify, during the scanning operation and using the machine learning model, a first content segment and a second content segment in the first data unit;
determine, during the scanning operation, using the smart contracts, and based on the distributed ledger, whether the user is permitted to access the first content segment;
determine, during the scanning operation, using the smart contracts, and based on the distributed ledger, whether the user is permitted to access the second content segment; and
generate, with the scanning device, in response to determining that the user is permitted to access the first content segment, and in response to determining that the user is not permitted to access the second content segment, a modified scan of the first data unit, wherein the modified scan comprises the first content segment and does not comprise the second content segment.

15. A computer program product for extracting discrete data from a data unit and managing access thereto using electronic digital certificates, the computer program product comprising a non-transitory computer-readable medium comprising code that, when executed by a first apparatus, causes the first apparatus to:
receive, from a plurality of input channels, data units, wherein each data unit of the data units comprises content;
identify, using a machine learning model and for each data unit of the data units, content segments in the data unit, wherein each content segment of the content segments is a portion of the content of the data unit;
determine, for each content segment of the content segments, qualifications permitting access to the content segment;
generate, for each content segment of the content segments, an electronic digital certificate to generate electronic digital certificates associated with the content segments;
store the electronic digital certificates on a distributed ledger;
generate, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated;
automatically permit, using the smart contracts and based on the distributed ledger, applications to access first content segments of the data units based on determining that the applications satisfy the qualifications permitting access to the first content segments; and
automatically prevent, using the smart contracts and based on the distributed ledger, the applications from accessing second content segments of the data units based on determining that the applications do not satisfy the qualifications permitting access to the second content segments.

16. The computer program product of claim 15, wherein the non-transitory computer-readable medium comprises code that, when executed by the first apparatus, causes the first apparatus to:
receive, from an application having attributes, a request to access a first data unit of the data units;
determine, using the smart contracts and based on the attributes of the application, a first content segment of the first data unit the application is permitted to access and a second content segment of the first data unit the application is not permitted to access; and
provide, to the application, access to the first content segment while preventing the application from accessing the second content segment.

17. The computer program product of claim 15, wherein, for each data unit of the data units, each content segment of the content segments comprises a field of the data unit and data in the field.

18. The computer program product of claim 15, wherein the non-transitory computer-readable medium comprises code that, when executed by the first apparatus, causes the first apparatus to, when determining the qualifications permitting access to the content segment, determine the qualifications based on a data security rule database.

19. The computer program product of claim 15, wherein the non-transitory computer-readable medium comprises code that, when executed by the first apparatus, causes the first apparatus to, when determining the qualifications permitting access to the content segment, determine the qualifications based on characteristics of the content segment, wherein the characteristics comprise at least one of:
whether the content segment comprises personally identifiable information;
whether the content segment comprises confidential information;
one or more uses of the content segment;
a type of data in the content segment; or
a type of a data unit containing the content segment.

20. A method for extracting discrete data from a data unit and managing access thereto using electronic digital certificates, the method comprising:
receiving, from a plurality of input channels, data units, wherein each data unit of the data units comprises content;
identifying, using a machine learning model and for each data unit of the data units, content segments in the data unit, wherein each content segment of the content segments is a portion of the content of the data unit;
determining, for each content segment of the content segments, qualifications permitting access to the content segment;
generating, for each content segment of the content segments, an electronic digital certificate to generate electronic digital certificates associated with the content segments;
storing the electronic digital certificates on a distributed ledger;
generating, on the distributed ledger, smart contracts for managing access to the electronic digital certificates by generating, for each electronic digital certificate, a smart contract permitting access to the electronic digital certificate based on the qualifications permitting access to the content segment of the content segments for which the electronic digital certificate was generated;
automatically permitting, using the smart contracts and based on the distributed ledger, applications to access first content segments of the data units based on determining that the applications satisfy the qualifications permitting access to the first content segments; and
automatically preventing, using the smart contracts and based on the distributed ledger, the applications from accessing second content segments of the data units based on determining that the applications do not satisfy the qualifications permitting access to the second content segments.
